(19) United States
(12) Patent Application Publication
(10) Pub. No.: US 2007/0178852 A1
(43) Pub. Date: Aug. 2, 2007

(54) Communication device

(76) Inventor: Roger L. Young, Radcliff, KY (US)

Correspondence Address: Galasso & Associates, LP, P.O. Box 26503, Austin, TX, 78755-0503, US

(21) Appl. No.: 11/343,458

(22) Filed: Jan. 31, 2006

(51) Int. Cl. H04B 1/38

(52) U.S. Cl. 455/90.3

(57) ABSTRACT

A communication device including cell phone which functions as a satellite phone, a pager and a television. The cell phone is equipped with a full alphabetic keyboard having three sections that fold up and attach to the back of the cell phone. The keyboard is connected to the bottom of the cell phone by a hinge that allows the keyboard to rotate and connect to the back of the cell phone. The cell phone comprises a USB port that allows the cell phone to attach to an external drive and is equipped with the ability to connect to a wireless internet.

### FIELD OF THE DISCLOSURE

A cell phone that is equipped with a computer keyboard and the capability to receive and transmit satellite signal as well as a regular cell phone signal.

### BACKGROUND

Cell phones have become very popular. In fact, almost everyone over the age of 16 has a cell phone and the number of cell phones used by those under the age of 16 has grown rapidly. Cell phones have become so popular that schools have even had to set rules and limitations for carrying them at school. Laws for driving while talking on a cell phone have also be instituted as the number of people communicating on cell phones while driving has exploded.

Business people don't seem to be able to function anymore without a cell phone. Airlines are even looking at changing the rules for cell phones on airplanes. Cell phone have become so popular that they are now a way of life not a luxury of life.

Aside from cell phones, computers and email have become a standard way of communicating and doing business. It seems that everyone has an email address and documents are communicated via email at an enormous rate. Even the courts have started accepting, and actually prefer, electronic filings. Applying for jobs via the internet has also become very popular. Even if you go to a store to apply for a job, lots of stores have computer set up for submitting an application.

PDAs are also a very popular item these days. It allows business people to store and carry lots of information with them. PDAs allow the user to sync with their computers to keep information current on both electronic devices. For example, if you update your computer with new addresses or telephone numbers then sync your PDA with your computer, the new information is then downloaded on the PDA. This allows the user to keep information current on the PDA with very little effort. PDAs not only serve to store and carry information, they fiction as a phone and are capable of sending and receiving email.

Text messaging has become quite the rage, especially with the younger crowd. The ability to write a message using the keys on the telephone keypad and then send it to another phone number, allows anyone with a cell phone to communicate via written communication with anyone else who has a cell phone. Text messaging is very similar to instant messaging, in that the messages are delivered very quickly and, depending on the ability of the user to type a message using the telephone keypad, a response can be returned very quickly.

Laptops are also a very useful item that most business people utilize these days. When business people travel, most of them will take a laptop along so that they can more easily check email and have the ability to prepare documents, if necessary. While laptops are very popular, they are very cumbersome for carrying on airplanes these days. Not only do they become very heavy if you have to carry them for a long way, but they must be removed from their case for clearing security. If you are in a hurry to catch a plane, this can be problematic.

Reducing the number of items that business people have to carry and then making the necessities as compact as possible, would be very appealing to anyone who has to travel a lot for business, or anyone who simply does not work in an office, like people who do outside sales. The advantage to keeping people connected electronically is that business can keep a closer watch on what their employees are doing and/or they can communicate with their employees quicker and more easily.

### SUMMARY OF THE DISCLOSURE

In one embodiment the communication device comprises a cell phone.

In another embodiment the cell phone comprises a flip cover for protecting the display screen.

In still another embodiment the communication device comprises a computer keyboard.

In yet another embodiment the keyboard folds out from the back of the cell phone.

In another embodiment the computer keyboard comprises a first section having a right side and a left side connected to the bottom of the cell phone by a hinge mechanism.

In still another embodiment the first section locks to the back of the cell phone.

In yet another embodiment the keyboard comprises a second section connected to the first section on the left side by a hinge mechanism.

In another embodiment the keyboard comprises a third section connected to the first section on the right side by a hinge mechanism.

In still another embodiment the first section lock is released by pressing a release button on the cell phone.

In yet another embodiment the communication device comprises a rechargeable battery operable to provide power.

In another embodiment the communication device comprises an antenna operable to receive and transmit a signal.

In still another embodiment the communication device is operable to function as a satellite phone.

In yet another embodiment the communication device is operable to function as a television.

In another embodiment the computer keyboard is a full alphabetic keyboard.

In still another embodiment the cell phone comprises a USB port operable to attach an external drive.

In yet another embodiment the battery is a 4.8 volt Ni—Cd Ultra Power battery.

In another embodiment the cell phone is operable to receive a wireless internet signal.

In still another embodiment the cell phone is operable to function as a pager.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a perspective view of a communication device

FIG. 2 is a back perspective view of the communication device described in FIG.1.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

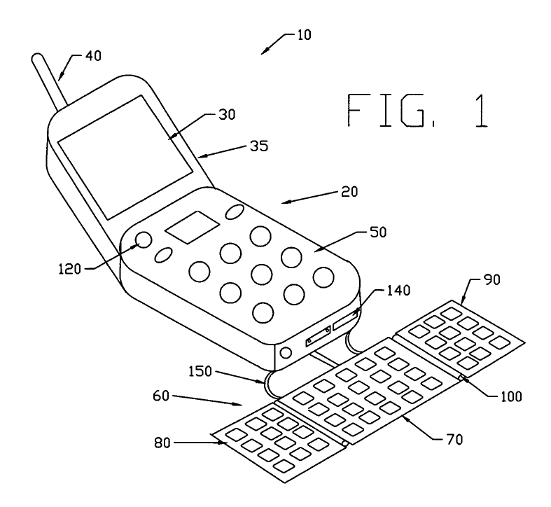

FIG. 1 illustrates a communication device 10 which includes a cell phone 20 having a display 30, a flip cover 35, an antenna 40 and a telephone keypad 50. This communication device 10 functions like a cell phone 20 but has additional functions as well. For example, the communication device 10 is operable to function as a satellite phone, a GPS system, video conferencing and as a television. Additionally, it is equipped with a full alphabetic keyboard 60. The alphabetic keyboard 60 is comprised of a first section 70, a second section 80 and a third section 90. The second section 80 and the third section 90 fold out from the first section 70 and are connected to the first section 70 by means of a hinge mechanism 100. When the alphabetic keyboard is folded up it attaches to the back of the communication device and locks into place. The lock 10 is released by pressing the release button 120 located on the telephone keypad 50. The communication device 10 is equipped with a battery 130 which attaches to the back of the cell phone 20 and is rechargeable. As with most cell phones, the battery is removable and replaceable since the batteries wear out over time. The cell phone 20, as shown in FIG. 1 is equipped with a flip cover 35 for protecting the display 30 when not in use. Even though FIG. 1 illustrates a cell phone 20 with a flip cover 35, other configurations of cell phones can be used.

The communication device is further equipped with a USB port 140. This allows the communication device 10 to be connected to a number of other devices, including an external drive which may include a CD/DVD read/write device, a printer, an external hard drive, a floppy drive as well as other devices which are capable of hooking up to the USB port 140. By having the USB port 140, it provides a lot of flexibility for someone who travels. Should they need to print something, all they have to do is go where there is a printer and then connect a USB cable to the communication device 10.

Since the communication device 10 functions as a cell phone 20, the user can purchase a wireless card that allows thereby allowing the user to have complete internet access where ever the wireless internet card allows service. Due to the fact that the communication device 10 has an alphabetic keyboard 60, the user can type out things quicker than using just the telephone keypad 50. This provides the common user with an easier means of making notes or even correcting documents that may be received via email. Also, it makes searching the internet or looking things up on the internet much faster and easier. While the cell phone 20 still provides for text messaging by use of the telephone keypad 50, being able to actually type using the alphabetic keyboard 60 makes it easier for functions that require more extensive typing or communication. Unless you are an experienced text messaging person, text messaging can be time consuming and somewhat confusing.

The communication device 10 when in use as a cell phone 20, has the ability to connect to a headset as well. Also, the cell phone battery can be charged from a base charger or via a car charger in the same manner as cell phones are currently charged. The communication device 10 is also capable of functioning as a pager in a similar manner as cell phones currently function as pagers.

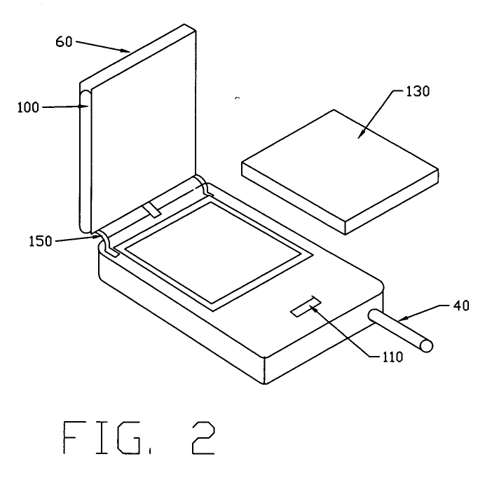

FIG. 2 illustrates the back of the communication device 10 and specifically shows the alphabetic keyboard 60 in a folded position. It further illustrates the lock 110 wherein the alphabetic keyboard 60 attaches to the back of the communication device 10. Additionally, the battery 130 is illustrated in a removed position. The battery 130 is inserted into the back of the communication device 10 and then the alphabetic keyboard 60 locks into place on top of the battery 130. By having the alphabetic keyboard 60 lock into place over the battery 130, access to the alphabetic keyboard 60 is easily accessible. The number of times that the alphabetic keyboard 60 will be used in comparison to the number of times the battery 130 is removed justifies having the alphabetic keyboard 60 fold over the battery 130.

FIG. 2 also provides a clearer view of the hinges 150 that attach the alphabetic keyboard 60 to the communication device 10. The hinges 150 fold into the back of the communication device to provide for a flat surface on the back of the communication device 10 when the alphabetic keyboard 60 is locked into place. FIG. 2 also illustrates the lock 110 which is located on the back of the communication device 10 for locking the alphabetic keyboard 60 in its closed position.

The communication device 10 is designed to be a multi-purpose device which allows for the reduction in the amount of communication devices that must be carried by an individual. By having the communication device 10 function as a cell phone 20, a pager and a satellite phone, it provides flexibility and ensures the ability to communicate from most anywhere. Equipping the communication device 10 with an alphabetic keyboard 60 provides the user with the ability to communicate via written communication with greater ease. Having a USB port 140 provides an enormous amount of flexibility for transferring information into or out of the communication device 10, thereby allowing the user the ability to reduce the amount of equipment that must be carried for communication.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A communication device comprising:
a cell phone comprising a flip cover for protecting the display screen;
a computer keyboard that is attached to the back of said cell phone and folds out from beneath the back of said cell phone; said computer keyboard further comprising;
a first section having a right side and a left side and connected to the bottom of said cell by a hinge mechanism and is locked to the back of said cell phone;
a second section connected to said first section on said left side by a hinge mechanism; and
a third section connected to said first section on said right side by a hinge mechanism; and
wherein said first section lock is release by pressing a release button located on said cell phone;
a rechargeable battery operable to provide power; and
an antenna operable to receive and transmit a signal.

2. The communication device of claim 1, wherein said cell phone is operable to function as a satellite phone.

3. The communication device of claim 1, wherein said cell phone is operable to function as a television.

4. The communication device of claim 1, wherein said computer keyboard is a full alphabetic keyboard.

5. The communication device of claim 1, wherein said cell phone further comprising a USB port operable to attach an external drive.

6. The communication device of claim 1, wherein said battery is a 4.8 volt Ni—Cd Ultra Power battery.

7. The communication device of claim 1, wherein said cell phone is operable to receive a wireless internet signal.

8. The communication device of claim 1, wherein said cell phone is operable to function as a pager.

9. A communication system comprising:
a cell phone comprising a flip cover for protecting the display screen;
a computer keyboard that is attached to the back of said cell phone and folds out from beneath the back of said cell phone; said computer keyboard further comprising;
a first section having a right side and a left side and connected to the bottom of said cell by a hinge mechanism and is locked to the back of said cell phone;
a second section connected to said first section on said left side by a hinge mechanism; and
a third section connected to said first section on said right side by a hinge mechanism; and
wherein said first section lock is release by pressing a release button located on said cell phone;
a USB port operable to attach an external drive;
a rechargeable battery operable to provide power; and
an antenna operable to receive and transmit a signal.

10. The communication device of claim 9, wherein said cell phone is operable to function as a satellite phone.

11. The communication device of claim 9, wherein said cell phone is operable to function as a television.

12. The communication device of claim 9, wherein said keyboard is a full alphabetic keyboard.

13. The communication device of claim 9, wherein said battery is a 4.8 volt Ni—Cd Ultra Power battery.

14. The communication device of claim 9, wherein said cell phone is operable to receive a wireless internet signal.

15. The communication device of claim 9, wherein said cell phone is operable to function as a pager.

16. A communication device comprising:
a cell phone comprising a flip cover for protecting the display screen; a cell phone comprising a flip cover for protecting the display screen;
a computer keyboard that is attached to the back of said cell phone and folds out from beneath the back of said cell phone; said computer keyboard further comprising;
a first section having a right side and a left side and connected to the bottom of said cell by a hinge mechanism and is locked to the back of said cell phone;
a second section connected to said first section on said left side by a hinge mechanism; and
a third section connected to said first section on said right side by a hinge mechanism; and
wherein said first section lock is release by pressing a release button located on said cell phone;
a release button on the front of said cell phone operable to release said computer keyboard from the back of said cell phone thereby allowing said computer keyboard to fold out at the bottom of said cell phone;
a USB port located on the side of said cell phone wherein said USB port is operable to attach an external drive;
a 4.8 volt Ni—Cd Ultra Power rechargeable battery operable to provide power wherein said battery is located on the opposite side of the telephone key pad; and
an antenna operable to receive and transmit a signal.

17. The communication device of claim 16, wherein said cell phone is operable to receive a wireless internet signal.

18. The communication device of claim 16, wherein said cell phone is operable to function as a television.

19. The communication device of claim 16, wherein said cell phone is operable to function as a satellite phone.
